(19) United States
(12) Patent Application Publication
(10) Pub. No.: US 2025/0214880 A1
(43) Pub. Date: Jul. 3, 2025

(54) MANUFACTURING METHOD OF OPTICAL FIBER PREFORM, OPTICAL FIBER PREFORM, AND OPTICAL FIBER

(71) Applicant: Shin-Etsu Chemical Co., Ltd., Tokyo (JP)

(72) Inventor: Hiroshi MATSUNO, Ibaraki (JP)

(21) Appl. No.: 19/082,048

(22) Filed: Mar. 17, 2025

Related U.S. Application Data
(63) Continuation of application No. PCT/JP2023/034284, filed on Sep. 21, 2023.

(30) Foreign Application Priority Data
Sep. 21, 2022 (JP) 2022-150388

(51) Int. Cl. C03B 37/012

(52) U.S. Cl. CPC C03B 37/01205

(57) ABSTRACT

Provided is a manufacturing method of an optical fiber preform, comprising: depositing SiO₂ fine particles by adhesion onto a starting preform formed of quartz glass to obtain a soot preform, the starting preform including a core having a high refractive index and a cladding having a lower refractive index than the core; sintering the soot preform to dehydrate and vitrify it sequentially from one end in a dehydration gas atmosphere; and prior to the sintering, preheating at least a vicinity of a sintering-process-start end of the soot preform. Provided is an optical fiber preform formed of quartz glass and including a core having a high refractive index and a cladding having a lower refractive index than the core, wherein an average of OH concentrations in a radial direction of the optical fiber preform is 25 ppm or less throughout a section of 90% or more in a longitudinal direction.

The contents of the following patent application(s) are incorporated herein by reference:
NO. 2022-150388 filed in JP on Sep. 21, 2022
NO. PCT/JP2023/034284 filed in WO on Sep. 21, 2023.

### BACKGROUND

### 1. Technical Field

The present invention relates to a manufacturing method of an optical fiber preform, an optical fiber preform, and an optical fiber.

### 2. Related Art

An external deposition method is known as a manufacturing method of an optical fiber preform. The external deposition method is one in which, for example, a raw material is caused to react in an oxyhydrogen flame to obtain SiO₂, and obtained SiO₂ is injected and deposited onto a starting preform formed of quartz glass as a main component to manufacture a soot preform. Subsequently, the soot preform is heat-treated from one end thereof to the other end sequentially at 1400 to 1600° C. in a furnace core tube, which is formed of a thermal-resistant material such as carbon or quartz and is provided with a heater on its outer circumference, while a mixed gas atmosphere of a chlorine-based gas and an inert gas being flowed into the furnace core tube, and then the soot preform is dehydrated and vitrified simultaneously to make it into a transparent glass preform for an optical fiber.

### BRIEF DESCRIPTION OF THE DRAWINGS

FIG. 1 shows a schematic configuration of a soot preform 4 in the present embodiment.

FIG. 2 shows a schematic configuration of a sintering furnace 1.

FIG. 3 is a descriptive drawing of a sintering process in an example 1.

FIG. 4 is a descriptive drawing of the sintering process in the example 1.

FIG. 5 is a descriptive drawing of a method for measuring absorbance and OH concentration of the glass preform 4.

FIG. 6 is a descriptive drawing of the method for measuring absorbance and OH concentration of the glass preform 4.

FIG. 7 is a graph showing a relationship between the absorbance (absorbance/diameter (cm⁻¹)) and a wavenumber (cm⁻¹) of transmitted infrared light.

FIG. 8 is a graph showing a relationship between a difference in absorbance (absorbance/diameter (cm⁻¹)) and a wavenumber (cm⁻¹) of transmitted infrared light.

FIG. 9 is a graph showing a distribution of integral values A (cm⁻²) in a longitudinal direction of the glass preform 4, from the wavenumber (cm⁻¹) of 3610 cm⁻¹ to 3740 cm⁻¹ of the infrared light of the example 1.

FIG. 10 is a graph showing an OH concentration distribution in a radial direction of a sintering-process-start end (longitudinal position of 100%) of the glass preform 4 of example 1.

FIG. 11 is a graph showing the OH concentration distribution on an interface in the longitudinal direction of the glass preform 4 of the example 1.

FIG. 12 is a graph showing the distribution of the OH concentrations in the longitudinal direction of the glass preform 4 of the example 1.

FIG. 13 is a graph showing the distribution of the OH concentrations in the longitudinal direction of the glass preform 4 of the example 1.

FIG. 14 is a graph showing integral values A (cm⁻²) of infrared absorption from 3610 to 3740 (cm⁻¹) in the longitudinal direction of the optical fiber preform of the example 2.

FIG. 15 is a graph showing the distribution of the OH concentrations in the longitudinal direction of the glass preform 4 of the example 2.

FIG. 16 is a table showing average OH concentrations in the radial direction and transmission losses of the examples 3 to 11.

FIG. 17 is a table showing OH concentrations near the interface of the examples 12 to 16.

FIG. 18 is a graph showing integral values A (cm⁻²) of infrared absorption from 3610 to 3740 (cm⁻¹) in the longitudinal direction of the glass preform 4 of a comparative example.

FIG. 19 is a graph showing the distribution of the OH concentrations on the interface in the longitudinal direction of the glass preform 4 of the comparative example.

FIG. 20 is a graph showing the distribution, in the longitudinal direction, of average values of the OH concentration in the radial direction of the glass preform 4 of the comparative example.

FIG. 21 is a graph showing the OH concentration distribution in the radial direction at a position of the sintering-process-start end of 100% of the comparative example.

### DESCRIPTION OF EXEMPLARY EMBODIMENTS

Hereinafter, the present invention will be described through embodiments of the invention. The embodiments below do not limit the invention according to the claims. Not all combinations of features described in the embodiments are essential for the solution of the invention.

Hereinafter, the manufacturing method of the optical fiber preform in the present embodiment will be described in detail with reference to the examples and the comparative examples.

### Example 1

### Deposition Process

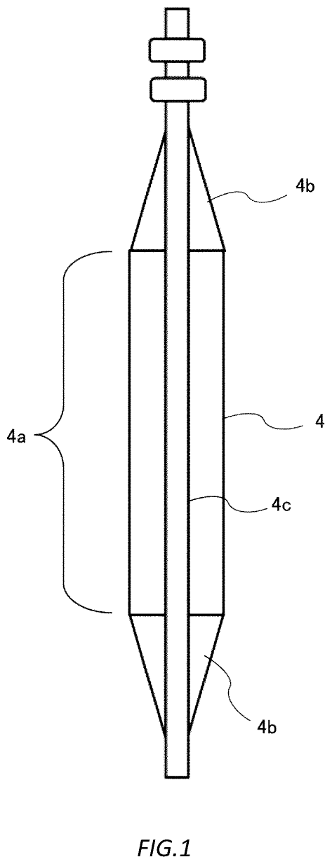

FIGS. 1 to 4 are descriptive drawings of the manufacturing method of the optical fiber preform in the present embodiment. FIG. 1 shows a schematic configuration of a soot preform 4 manufactured by the deposition process. To manufacture the optical fiber preform, firstly, the soot preform 4 with tapered portions at both ends, as shown in FIG. 1, is manufactured by depositing SiO₂ fine particles onto a starting preform formed of quartz glass as a main component. As shown in FIG. 1, the soot preform 4 includes a straight body portion 4a, a tapered portion 4b, and a central axis 4c. Note that, a position on a diameter of the soot preform 4 which corresponds to an interface between the starting preform and the deposited SiO₂ fine particle layer (OVD layer: outside vapor deposition) may be simply referred to as an “interface” in some cases. A ratio of the diameter of the starting preform to the diameter of the soot preform 4 is approximately 0.3, and thus, when the diameter of the soot preform 4 is assumed to be 1, the position of the interface is located at around 0.35 and 0.65 in the radial direction.

### Preheating Process

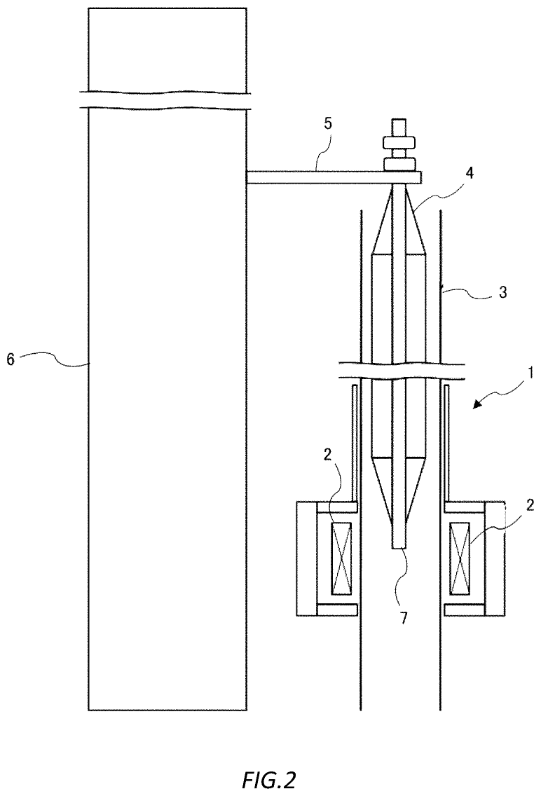

FIG. 2 shows a schematic configuration of the sintering furnace 1. The optical fiber preform of the example 1 is obtained by performing dehydration and vitrification simultaneously on the soot preform 4 after the soot preform 4 is formed. As shown in FIG. 2, the soot preform 4 is set on a preform-receiving stand 5 of a reverse pole 6 and reversed to be positioned immediately above a furnace core tube 3 of a sintering furnace 1. Here, the soot preform 4 is set above the furnace core tube 3 so that the handle portion 7 of the lower-end side of the soot preform 4 is away from the center of the main heater 2 by about 40 to 60 mm.

Once the soot preform is set in the sintering furnace 1 shown in FIG. 2, a preheating process is performed in which at least the vicinity of a sintering-process-start end of the soot preform 4 is preheated in the temperature atmosphere of 800° C. or more and 1300° C. or less for a range of 30 minutes or more and 480 minutes or less. Note that, the sintering-process-start end refers to the lower end of the straight body portion 4a of the soot preform 4 in FIG. 2. The vicinity of the sintering-process-start end refers to a region spanning to a position of 10% of the preform from the side of the sintering-process-start end in the longitudinal direction. That is, it refers to a section of 10% of the entire length of the straight body portion extending from the lower end of the straight body portion 4a of the soot preform 4 to the inside of the straight body portion 4a. Note that, values than other 10% may be applied.

The bulk density of the large-sized soot preform 4 is 0.8 g/cm³ or less, the radius of the straight body portion 4a is 150 mm or more, and the length of the straight body portion 4a is 1500 mm or more. When the length of the straight body portion 4a is 1500 mm, the vicinity of the sintering-process-start end is a section of 150 mm from the lower end of the straight body portion 4a, and in the preheating process, preheating is performed so that the temperature of this section becomes 800° C. or more and 1300° C. or less.

In the preheating process, it is preferable that the soot preform 4 is preheated while being rotated at 3 rpm or less in the atmosphere that includes at least one or more of N₂, O₂, Ar, He, or Cl₂ gases. In addition, in the preheating process, it is preferable that the end surface of the handle portion 7 and/or the side surface of the handle portion 7 exposed to the outside of the soot preform 4 on the side of the sintering-process-start end is/are installed in a sintering furnace so as to be exposed to the radiant heat from the main heater 2 for sintering, and the radiation from the main heater 2 is propagated, as an infrared radiation, through the handle portion 7 and the starting preform to heat the soot preform 4 from inside.

In the example 1, as the preheating process, the heater temperature was set to 1100° C., the upper portion of the furnace core tube 3 was kept open to the atmosphere for two hours, and the tapered portion 4b on the lower-end side of the soot preform 4 was preheated before sintering and vitrifying it. Note that, the heater temperature refers to a value of the temperature of the main heater 2 at its vertically centered position measured by a thermocouple.

Accordingly, as to the soot preform 4 warmed in the preheating process, an enough time for the dehydration reaction can be ensured in the dehydration gas atmosphere even in the vicinity of the process-start end in which the vitrification starts earlier, before the soot preform 4 reaches the temperature at which the vitrification is caused, and thus by performing the dehydration sintering process in the subsequent sintering process, the optical fiber preform with sufficiently low OH concentration in the vicinity of the sintering-process-start end can be obtained, as will be described below.

### Sintering Process

Once the preheating process finishes, then the sintering process is performed where the soot preform 4 is dehydrated and vitrified sequentially from one end thereof in the dehydration gas atmosphere. In the sintering process, the heater temperature is raised to about 1400 to 1600° C. and the preheated soot preform 4 is caused to pass through the heating section of the heater while being drawn downwardly at the moving rate, for example, of 5 mm/minute in the mixed gas atmosphere of a chlorine-based gas and an inert gas, and thereby the soot preform 4 is dehydrated and vitrified and the transparent glass preform 4 (hereinafter, described with the same reference numeral as the soot preform) for an optical fiber is obtained. In the sintering process, it is preferable that the soot preform 4 is rotated at 3 rpm or less while being sintered.

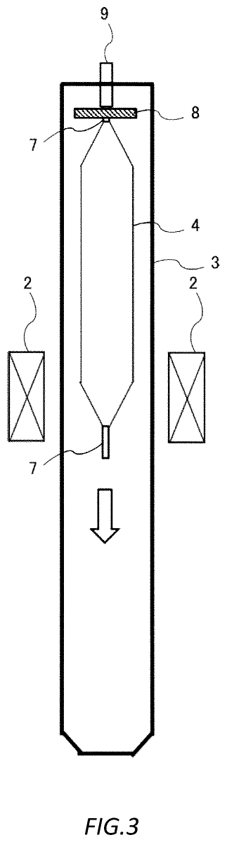

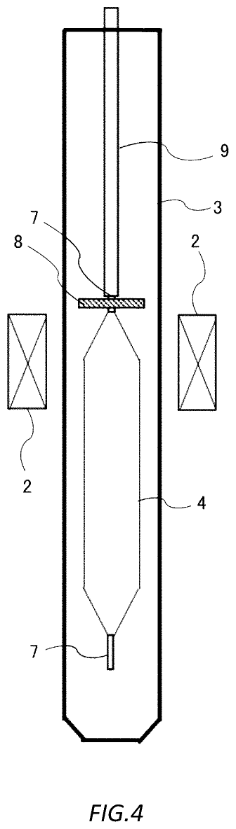

FIG. 3 and FIG. 4 are descriptive drawings of the sintering process in the example 1. As shown in FIG. 3, the handle portion 7 in the upper end of the soot preform 4 after the preheating process was connected to a hanging shaft 9 of a preform-hanging mechanism, and the hanging shaft 9 and the soot preform 4 were connected and fixed with each other with a pin, and then as shown in FIG. 4, the soot preform 4 was drawn downwardly to a sintering start position, and the sintering was started with a lid of the furnace core tube 3 closed. Note that, a heat shield plate 8 having a disk shape with a thickness of 10 mm made of opaque quartz was attached to the handle portion 7 on the upper end of the soot preform 4 during the sintering. With such a heat shield plate 8, the vicinity of the sintering end position is sufficiently heated, and thus opaque portions, referred to as unmelted residue, are less likely to occur in the vicinity of the sintering-process-finish end.

In the example 1, the glass preform 4 for an optical fiber was manufactured by, after the start of the sintering, supplying He and Cl₂ at a predetermined flow rate as dehydration gas, setting the heater temperature to 1500° C., and drawing the soot preform 4 downwardly at the lowering rate of 5.0 mm/min, thereby dehydrating and vitrifying the soot preform 4. The glass preform 4 for an optical fiber is formed of quartz glass and includes a core having a high refractive index and a cladding having a lower refractive index than the core.

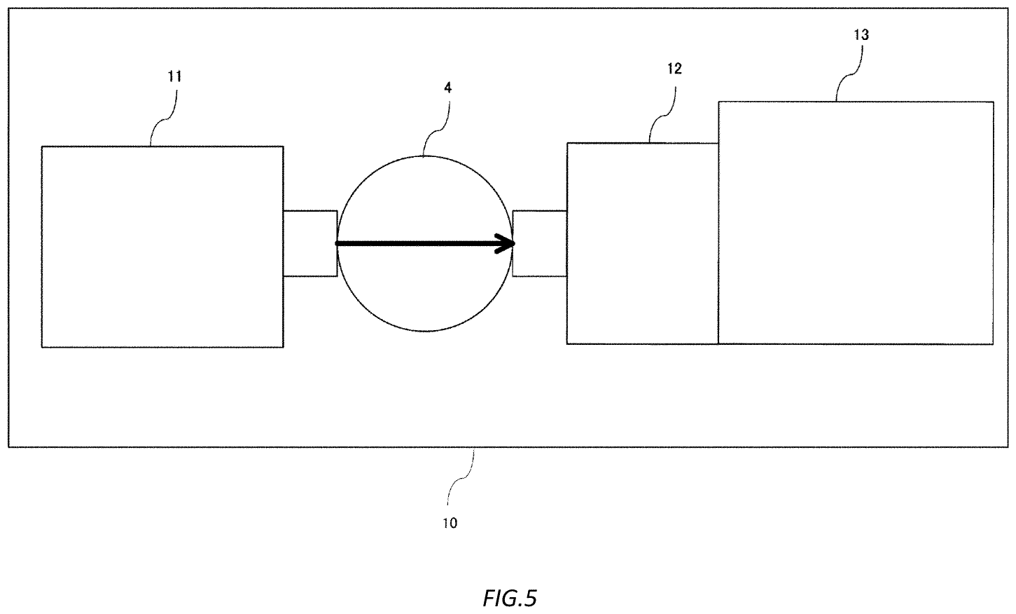

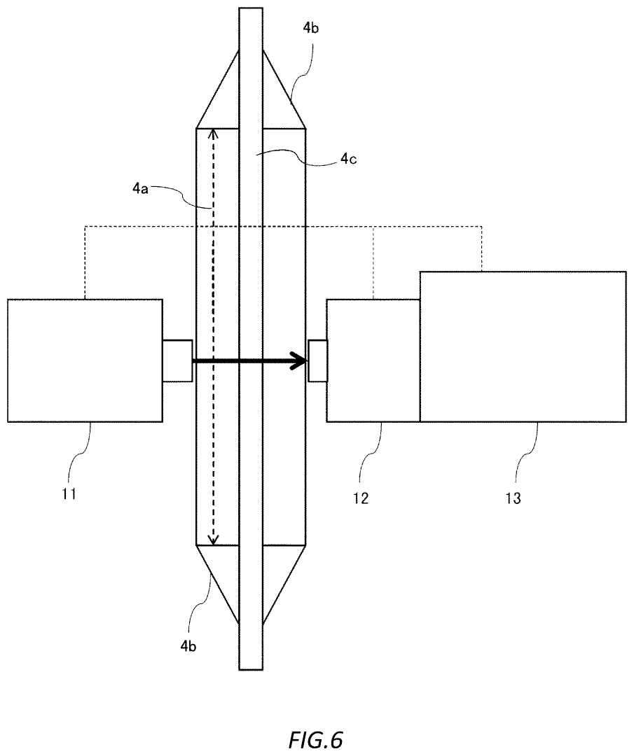

FIG. 5 and FIG. 6 are descriptive drawings of the method for measuring absorbance and OH concentration of the glass preform 4. FIG. 5 shows a side view seen in the direction of the central axis 4c of the glass preform 4, and FIG. 6 shows a top view seen in the direction perpendicular to the central axis 4c of the glass preform 4. As shown in FIG. 5 and FIG. 6, the infrared light measuring apparatus 10 includes an infrared light radiation mechanism 11, an infrared light reception mechanism 12, and a calculation mechanism 13. The transparent glass preform 4 for an optical fiber is arranged between the infrared light radiation mechanism 11 and the infrared light reception mechanism 12. As the infrared light measuring apparatus 10, Nicolet is 20 (registered trademark) FT-IR from Thermo Scientific is used, for example. A spot size of the infrared light as a measuring light is 10 mm, for example.

First, the method for measuring the absorbance of the glass preform 4 will be described. In the absorbance measurement, an infrared light is radiated to the glass preform 4 from the infrared light radiation mechanism 11 so that the infrared light as a measuring light passes through the center of the glass preform cross section, as shown in FIG. 5. In the radiated state of the infrared light, as shown in FIG. 6, the infrared light is perpendicular to the central axis 4c of the glass preform 4. In this state, a wavelength of the infrared light is scanned and the intensity of the transmitted infrared light received by the infrared light reception mechanism 12 is measured. A relationship between the wavenumber (cm⁻¹) of the transmitted infrared light and the absorbance is calculated by the calculation mechanism 13. The obtained absorbance is divided by the diameter (cm) of the glass preform 4 to calculate the absorbance per unit optical path length. This measurement is repeated while the position of incidence of the infrared light is moved from one end of the straight body portion 4a of the glass preform 4 to the other end along the longitudinal direction of the glass preform 4.

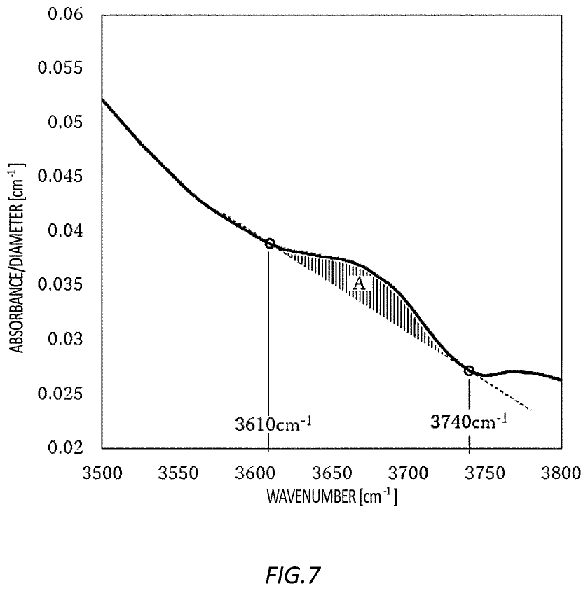

FIG. 7 is a graph showing the relationship between the absorbance per unit optical path length (absorbance/diameter (cm⁻¹)) and the wavenumber (cm⁻¹) of the transmitted infrared light. FIG. 7 shows the above-described relationship at a particular position of the glass preform 4 in the longitudinal direction. In the graph of FIG. 7, a straight line is drawn through a point of the wavenumber of 3610 (cm⁻¹) and a point of the wavenumber of 3740 (cm⁻¹), and an integral value A (cm⁻²) of the difference between this straight line and a curved line of the absorbance per unit optical path length is calculated between the point of the wavenumber of 3610 (cm⁻¹) and the point of the wavenumber of 3740 (cm⁻¹). Variation in the integral value A (cm⁻¹) at each position of the glass preform 4 in the longitudinal direction is evaluated. This integral value A (cm⁻²) is an indicator that varies according to the extent of unmelted residue of the glass preform 4, and a smaller integral value A (cm⁻²) is preferred because it becomes smaller when the unmelted residue is less.

Then, a method for measuring the OH concentration of the glass preform 4 will be described. In a method for manufacturing the glass preform 4 by performing dehydration and vitrification simultaneously, the vitrification may proceed before sufficient dehydration treatment is attained in the vicinity of the sintering-process-start end of the glass preform 4, and this may contribute to the instability of the optical property in the longitudinal direction of the glass preform 4. That is, insufficient dehydration treatment on the glass preform 4 results in an increased OH concentration in the vicinity of the sintering-process-start end of the glass preform 4, and thus the transmission loss at the wavelength of 1383 nm, known as an OH peak, of the optical fiber drawn from this part becomes higher than usual. Thus, it is important to promote the dehydration more reliably in the vicinity of the sintering-process-start end.

The measurement of the OH concentration of the glass preform 4 is a destructive inspection of the glass preform 4. The glass preform 4 is cut into circular slices at measurement positions in the longitudinal direction of the glass preform 4 to prepare a sample having a column shape with a thickness of 15 mm. The infrared light, as a measuring light, is arranged to enter into one of the bottom surfaces of the sample perpendicularly to the bottom surface and exit from another of the bottom surfaces. As the infrared light measuring apparatus 10, Nicolet is 20 (registered trademark) FT-IR from Thermo Scientific is used, for example. The measuring light enters into the sample through an opening of 1 by 1 mm square made in a light-shielding mask. In this state, a wavelength of the infrared light is scanned and the intensity of the transmitted infrared light received by the infrared light reception mechanism 12 is measured. The calculation mechanism 13 calculates the relationship between the wavenumber (cm⁻¹) and the absorbance. The absorbance difference from the absorbance data obtained from a reference glass measured separately is calculated. This measurement is repeated while the position of incidence of the infrared light is moved from a circumferential position of the bottom surface circle to an opposite circumferential position along the diameter through the center of the circle.

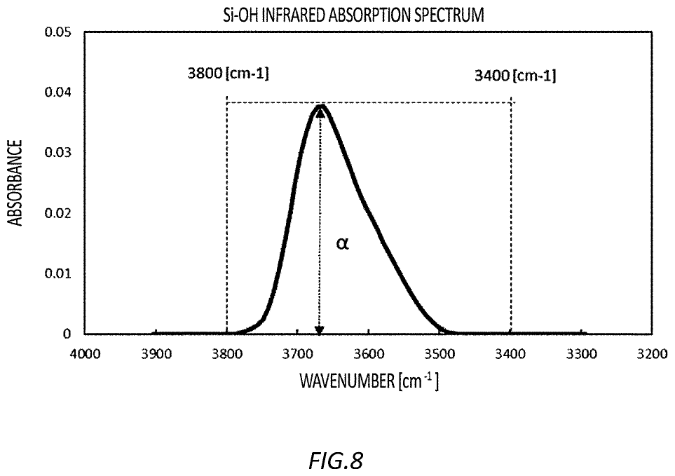

FIG. 8 is a graph showing the relationship between the difference in absorbance and the wavenumber (cm⁻¹) of the transmitted infrared light. In FIG. 8, a straight line is drawn through a point of the wavenumber of 3400 cm⁻¹ and a point of the wavenumber of 3800 cm⁻¹, and the difference between this straight line and the actually measured absorbance is shown in the graph. As shown in FIG. 8, the curved line representing the absorbance has a peak height α. The OH concentration of the glass preform 4 is calculated using the peak height α and the mathematical expression below. The calculation is based on Lambert-Beer law, and 90 L/mol cm is used as the value of the OH molar absorbance coefficient and 2.2 g/cm³ is used as the density of the glass preform 4 to calculate the OH concentration of the glass preform 4.

Mathematical expression: OH concentration=(peak height α×OH molecular weight)/(OH molar absorbance coefficient×density×optical path length)

The absorbance of the infrared light was measured at 80 or more measurement points set equally spaced along the diameter from the circumferential position of the column-shaped glass preform 4, cut into a circular slice, to the opposite circumferential position through the center of the circle on the diameter, and the OH concentration at each measurement point was calculated. Then, the average value and the maximum value of these OH concentrations were calculated, and the OH concentration distribution in the longitudinal direction of the glass preform 4 was evaluated.

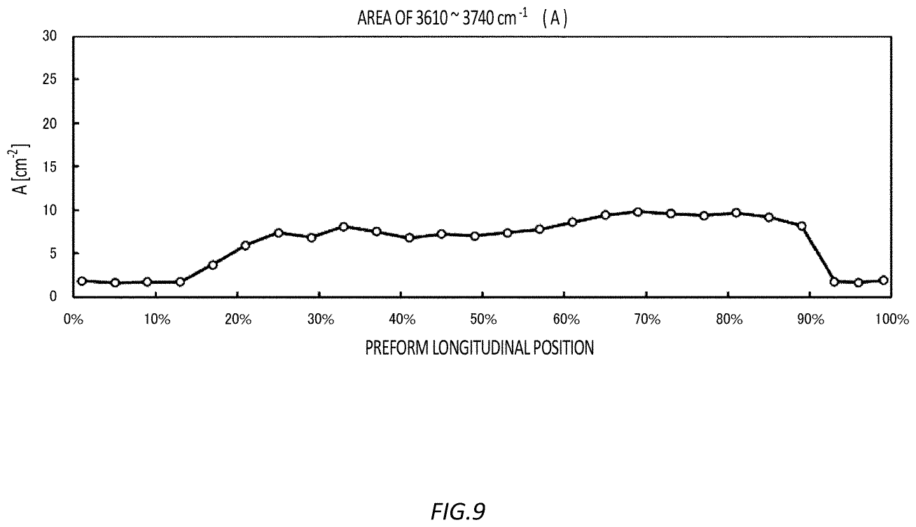

FIG. 9 is a graph showing the distribution of the integral values A (cm⁻²) in the longitudinal direction of the glass preform 4, from the wavenumber (cm⁻¹) of 3610 cm⁻¹ to 3740 cm⁻¹ of the infrared light of the example 1. For the glass preform 4 manufactured by the manufacturing method of the example 1, the absorbance was measured at a plurality of positions in the longitudinal direction of the straight body portion 4a of the glass preform 4 by using the infrared light measuring apparatus 10. In FIG. 9, the sintering-process-start end of the straight body portion 4a of the glass preform 4 is represented as 100% and the sintering-process-finish end is represented as 0%. The sintering-process-start end is the lower end of the glass preform 4 in FIG. 2 while the sintering-process-finish end is the upper end of the glass preform 4 in FIG. 2. As shown in FIG. 9, the integral values A are 10 (cm⁻²) or less throughout the entire region of the straight body portion 4a of the glass preform 4, indicating that the infrared absorption has been suppressed. In particular, the integral values A at the positions from 100% to 90% in the longitudinal direction, which corresponds to the vicinity of the sintering-process-start end, are 5 (cm⁻¹) or less. This indicates that the unmelted residue has been suppressed in the manufacturing process of the example 1.

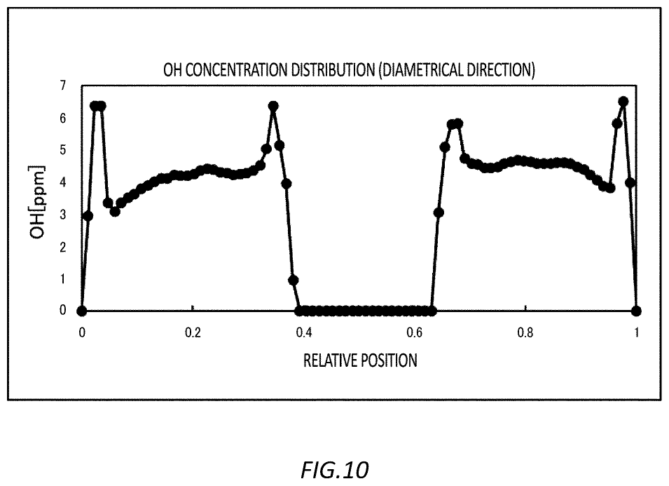

Then, the OH concentration distribution in the radial direction was measured at a plurality of positions in the longitudinal direction of the straight body portion 4a of the glass preform 4. FIG. 10 is the graph showing the OH concentration distribution in a radial direction of the sintering-process-start end of the glass preform 4 of example 1. As shown in FIG. 10, the OH concentrations at the positions of the interface (the positions of 0.35 and 0.65 on the horizontal axis in FIG. 10) were 10 ppm or less. Accordingly, it is observed that the dehydration has been sufficiently performed in the vicinity of the sintering-process-start end.

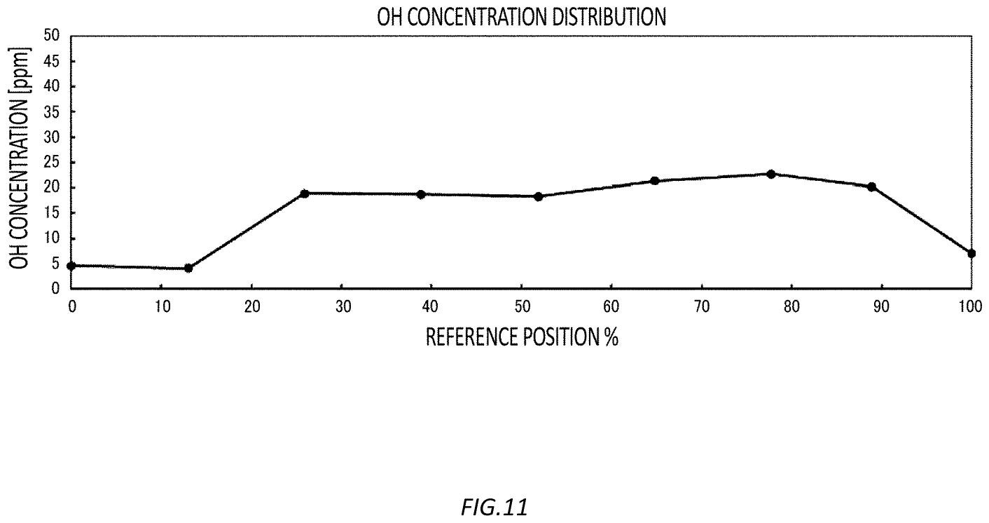

FIG. 11 is a graph showing the OH concentration distribution on the interface in the longitudinal direction of the glass preform 4 of the example 1. In FIG. 11, the sintering-process-finish end of the straight body portion 4a of the glass preform 4 is represented as 0% and the sintering-process-start end is represented as 100%. As shown in FIG. 11, the OH concentrations of the interface at the positions from 100% to 90% in the longitudinal direction, which corresponds to the vicinity of the sintering-process-start end, were 20 ppm or less, which were equivalent to or less than the values in the region from 20% to 80% of the straight body portion 4a. Accordingly, it is observed that the dehydration has been sufficiently performed in the vicinity of the sintering-process-start end.

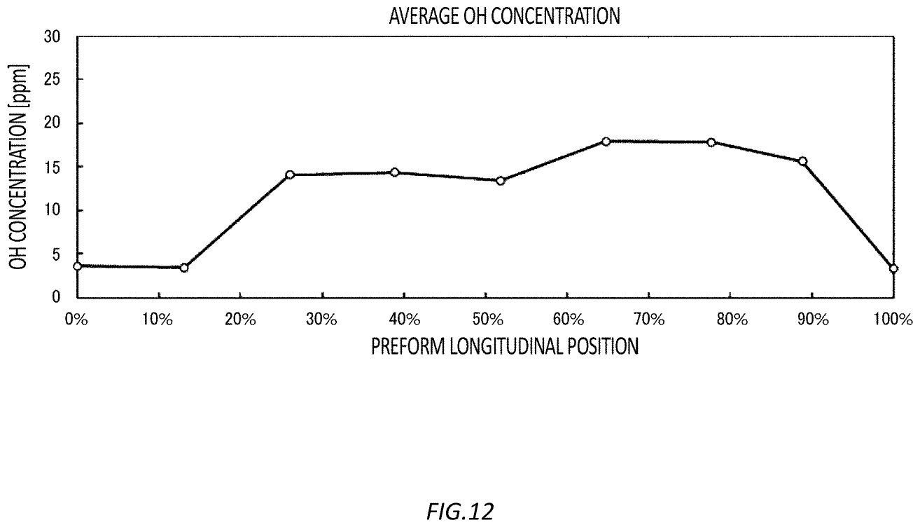

FIG. 12 is a graph showing the distribution of the OH concentrations in the longitudinal direction of the glass preform 4 of the example 1. FIG. 12 shows the average values of the OH concentrations in the radial direction of the glass preform 4. As shown in FIG. 12, the average values of the OH concentrations at the positions from 100% to 90% in the longitudinal direction, which corresponds to the vicinity of the sintering-process-start end, are 20 ppm or less, and the average values of the OH concentrations are 20 ppm or less throughout the entire glass preform 4 in the longitudinal direction. Accordingly, it is observed that the dehydration has been sufficiently performed in the vicinity of the sintering-process-start end.

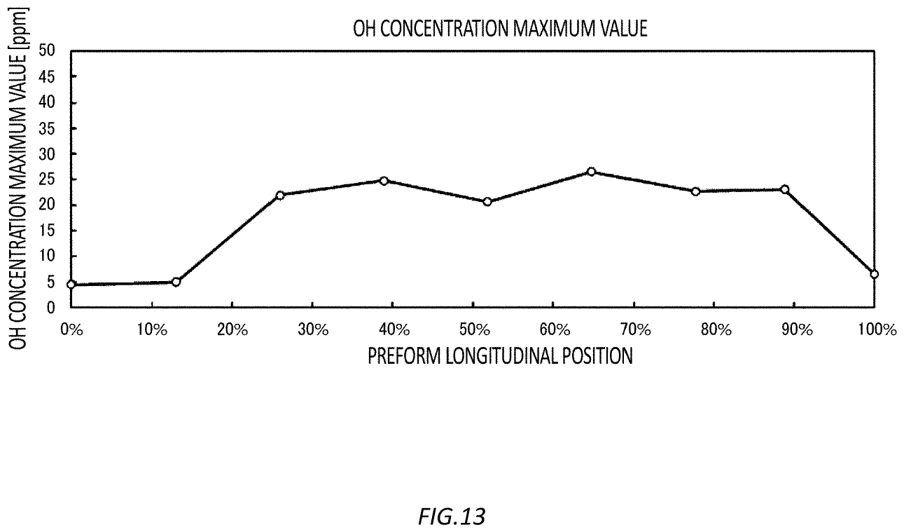

FIG. 13 is a graph showing the distribution of the OH concentrations in the longitudinal direction of the glass preform 4 of the example 1. FIG. 13 shows the maximum values of the OH concentrations in the radial direction of the glass preform 4. As shown in FIG. 13, the maximum values of the OH concentrations in the region from 100% to 90%, which corresponds to the vicinity of the sintering-process-start end, are 25 ppm or less, and the maximum values of the OH concentrations are 30 ppm or less throughout the entire glass preform 4 in the longitudinal direction. Accordingly, it is observed that the dehydration has been sufficiently performed in the vicinity of the sintering-process-start end.

When the transmission loss at the wavelength of 1383 nm of the optical fiber drawn from the glass preform 4 of the example 1 is measured, the obtained transmission loss of the optical fiber corresponding to the position of the vicinity of the sintering-process-start end of the straight body portion 4a of the glass preform 4 was equivalent to or less than the transmission loss of the optical fiber in the region from 20 to 80% of the straight body portion 4a of the glass preform 4, and the value was less than 0.295 (dB/km). This is because the dehydration has been sufficiently performed in the vicinity of the sintering-process-start end.

### Example 2

In the example 2, the same soot preform 4 as that of the glass preform 4 of the example 1 was fabricated and the preheating and sintering was performed in the same procedure as the example 1, except that the heat shield plate 8 was not attached to the handle portion 7 in the upper end of the soot preform 4 sintered.

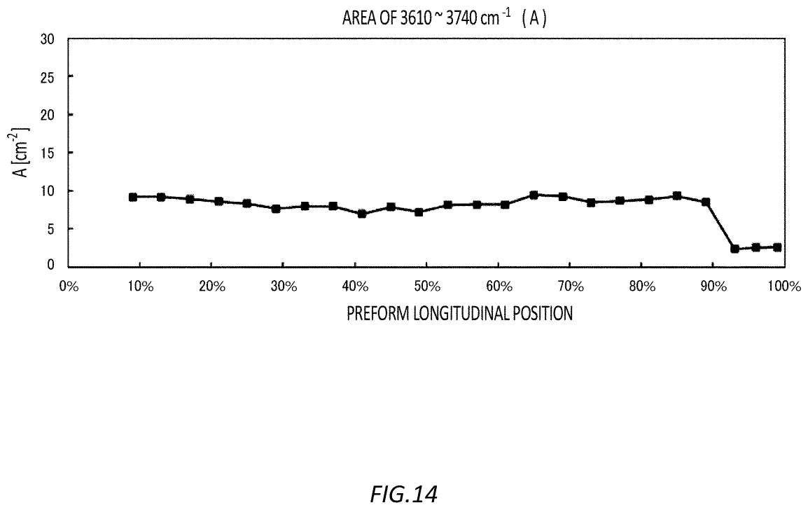

FIG. 14 is a graph showing the integral values A (cm⁻²) of the infrared absorption from 3610 to 3740 (cm⁻¹) in the longitudinal direction of the glass preform 4 of the example 2. As shown in FIG. 14, in the example 2, unmelted residue occurred in the vicinity of the sintering-process-finish end (longitudinal position of 0 to 8%) of the straight body portion 4a of the glass preform 4 and caused partial opaqueness, and thus measurement of the infrared absorption on this part was unfeasible. As shown in FIG. 14, the integral values A are 10 (cm⁻²) or less throughout the entire section measured. In particular, the integral values A at the positions from 100% to 90% in the longitudinal direction, which corresponds to the vicinity of the sintering-process-start end, are 5 (cm⁻²) or less.

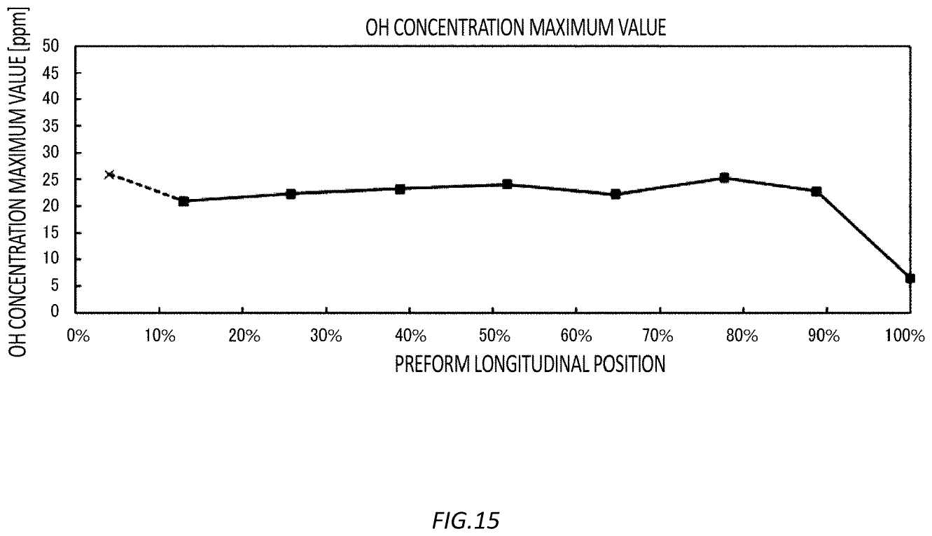

FIG. 15 is a graph showing the distribution of the OH concentrations in the longitudinal direction of the glass preform 4 of the example 2. FIG. 15 shows the maximum values of the OH concentrations in the radial direction of the glass preform 4. As shown in FIG. 15, the maximum values of the OH concentrations at the positions from 100% to 90% in the longitudinal direction, which corresponds to the vicinity of the process-start end, are 25 ppm or less, and the maximum values of the OH concentrations are 30 ppm or less throughout the entire glass preform 4 in the longitudinal direction. Note that, the OH concentration could not be entirely measured in the radial direction at a position of around 4% in the longitudinal direction corresponding to the vicinity of the sintering-process-finish end, because unmelted residue partially occurred at this position. Thus, the position of around 4% in the longitudinal direction is shown by x. The maximum value, shown in FIG. 15, of the OH concentration at the position of around 4% in the longitudinal direction is represented by the maximum value of the measurement result obtained from a transparent portion whose OH concentration could be measured.

### Examples 3 to 11

Nine soot preforms 4 were fabricated in the same way as the example 1, and the glass preforms 4 for an optical fiber were manufactured under the condition of the preheating temperature for each soot preform 4 set to 750° C., 850° C., 900° C., 1000° C., 1100° C., 1200° C., 1300° C., and 1400° C. and the preheating time for 60 minutes. The sintering-process-start end (the section from 100 to 98%) of the straight body portion 4a of each glass preform 4 was cut into a circular slice to measure the OH concentration distribution in the radial direction. In addition, the section from 98 to 90% of the straight body portion 4a was drawn to fabricate the optical fiber, and its transmission loss at the wavelength of 1383 nm was measured.

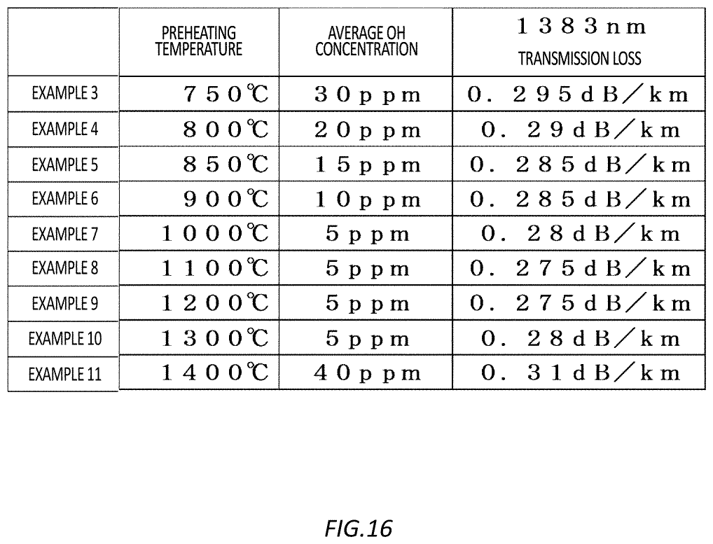

FIG. 16 is a table showing the average OH concentrations in the radial direction and transmission losses of the examples 3 to 11. As shown in FIG. 16, in the example 3 with the preheating temperature of 750° C., the average OH concentration was 30 ppm and the transmission loss of the optical fiber was 0.295 dB/km. In addition, in the example 11 with the preheating temperature of 1400° C., the average OH concentration was 40 ppm and the transmission loss of the optical fiber was 0.31 dB/km. In the examples 4 to 10 with the preheating temperature from 800° C. to 1300° C., the average OH concentrations were 20 ppm or less and the transmission losses of the optical fiber were also 0.29 dB/km or less.

As described above, good results were obtained regarding the average OH concentration and the transmission loss of the optical fiber by the preheating temperature of more than 750° C. and less than 1400° C. Note that, the sufficient preheating effect cannot be obtained by the preheating temperatures of 750° C. or less, and thus it is considered that no good result would have been obtained with these temperatures. In addition, it is considered that no good result was obtained with the preheating temperatures of 1400° C. or more, because these temperatures undesirably promote the densification of the SiO₂ fine particle porous body of the preheated portion, preventing the dehydration gas from penetrating sufficiently during the sintering process. Accordingly, the preheating temperature is preferably more than 750° C., and more preferably it is 800° C. or more. In addition, the preheating temperature is preferably less than 1400° C. and more preferably it is 1300° C. or less.

### Examples 12 to 16

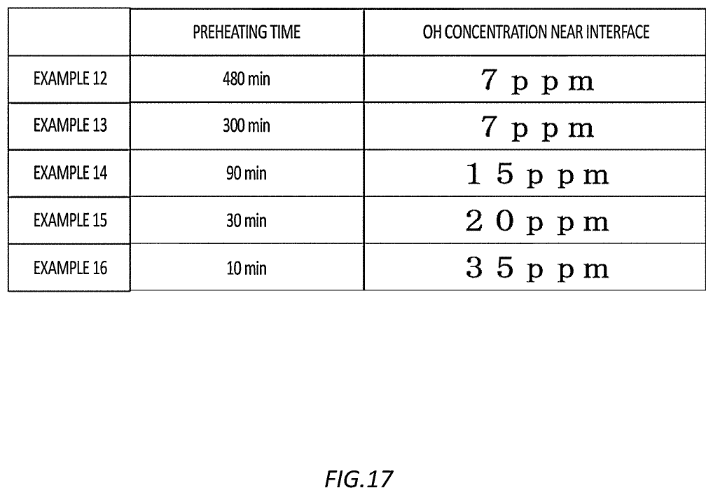

FIG. 17 is a table showing OH concentrations near the interface of the examples 12 to 16. Five soot preforms 4 were fabricated in the same way as the example 1, and the glass preforms 4 for an optical fiber were manufactured under the condition of the preheating temperature set to 800° C. and the preheating time for each soot preform 4 set to 480 minutes, 300 minutes, 90 minutes, 30 minutes, and 10 minutes. The sintering-process-start end (the section from 100 to 98%) of the straight body portion 4a of each glass preform 4 was cut into circular slices to measure the OH concentration distribution near the interface between the starting preform and the OVD layer.

As shown in FIG. 17, in the example 16 with the preheating time of 10 minutes, the OH concentration near the interface was 35 ppm. From this result, it is observed that the OH concentration does not decrease sufficiently near the interface because the soot preform 4 is not sufficiently heated to its center for the preheating time of 10 minutes. In the examples 12 to 15, the OH concentrations near the interface were 20 ppm or less. Accordingly, it is observed that the preheating time is preferably 30 minutes or more for heating to the center. On the other hand, the OH concentration does not tend to decrease significantly by preheating for longer than 480 minutes, and thus, considering the efficiency, the preheating time is preferably 480 minutes or less.

### Comparative Example

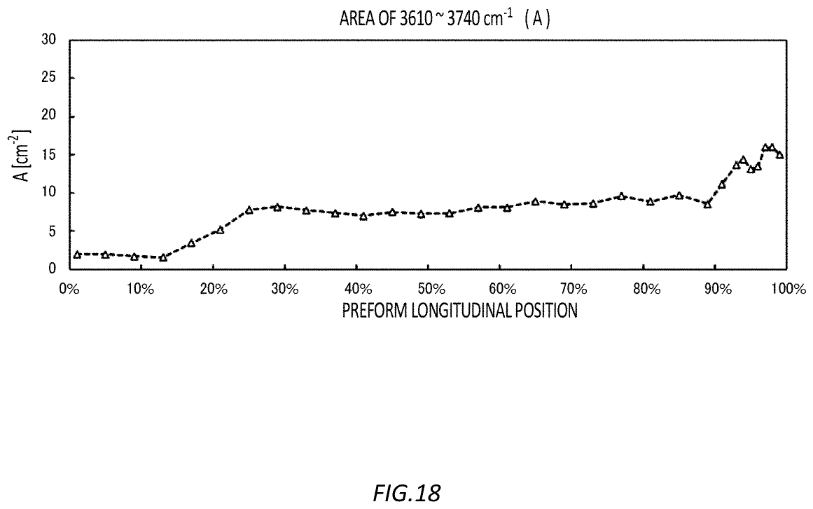

The soot preform 4 was sintered in the same way as that of the example 1 to manufacture the optical fiber preform, except that the preheating process was not provided. FIG. 18 is a graph showing the integral values A (cm⁻²) of the infrared absorption from 3610 to 3740 (cm⁻¹) in the longitudinal direction of the glass preform 4 of the comparative example. As shown in FIG. 18, the integral values A exceed 10 (cm⁻²), particularly at the positions from 100% to 90% in the longitudinal direction in the vicinity of the sintering-process-start end. This indicates that the unmelted residue has occurred because no preheating process is provided in the comparative example.

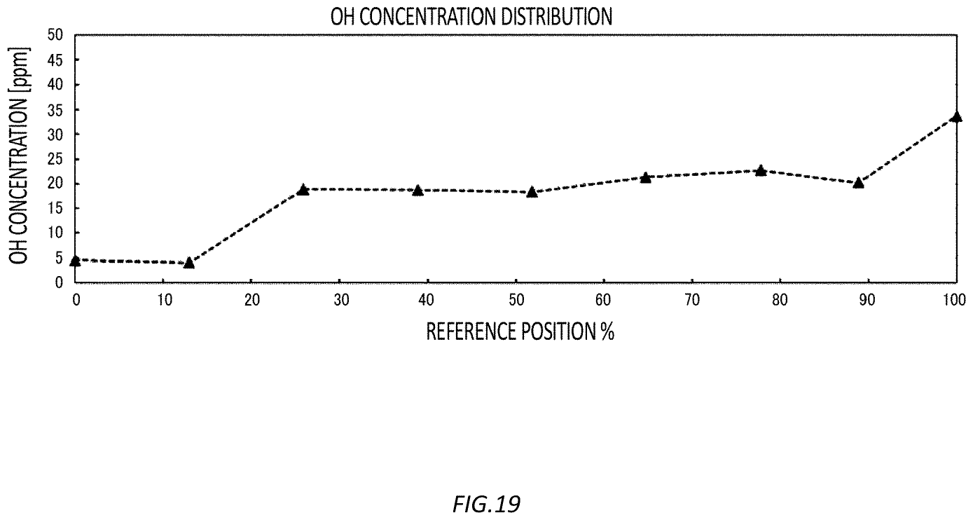

FIG. 19 is a graph showing the distribution of the OH concentrations on the interface in the longitudinal direction of the glass preform 4 of the comparative example. The glass preform 4 of the comparative example was cut into circular slices at multiple positions in the longitudinal direction of the glass preform 4 to measure the distribution of the OH concentrations of each slice in the radial direction. As shown in FIG. 19, it is observed that the OH concentrations of the interface at the positions from 100% to 90% in the longitudinal direction in the vicinity of the sintering-process-start end are higher compared to those of the region from 20 to 80%. Accordingly, it is observed that the dehydration has not been sufficiently performed in the vicinity of the sintering-process-start end because the preheating process is not provided.

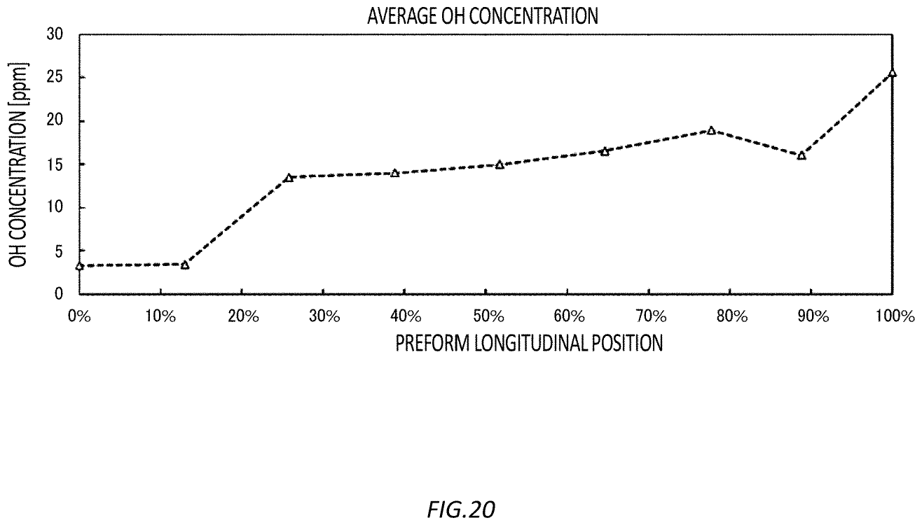

FIG. 20 is a graph showing the distribution, in the longitudinal direction, of average values of the OH concentration in the radial direction of the glass preform 4 of the comparative example. As shown in FIG. 20, the average OH concentration in the region from 100 to 90% corresponding to the vicinity of the sintering-process-start end exceeds 25 ppm. Accordingly, it is observed that the dehydration has not been sufficiently performed in the vicinity of the sintering-process-start end because the preheating process is not provided.

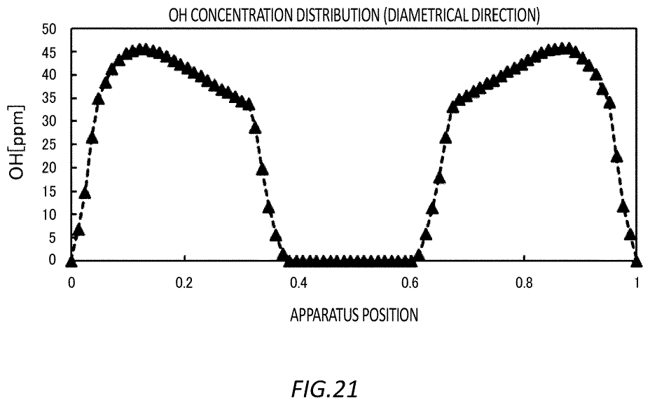

FIG. 21 is a graph showing the OH concentration distribution in the radial direction at the position of the sintering-process-start end 100% of the comparative example. As shown in FIG. 21, it is observed that the OH concentrations at the position of the interface (the positions of 0.35 and 0.65 on the horizontal axis in FIG. 21) are 30 ppm or more. Also, the transmission loss at the wavelength of 1383 nm in the optical fiber obtained by drawing the glass preform 4 of the comparative example in the vicinity of the position from 98% to 90% of the process-start end was 0.295 (dB/km) or more. This is because the dehydration has not been sufficiently performed in the vicinity of the sintering-process-start end.

### Effect

According to the manufacturing method of the optical fiber preform in the above-described embodiments, prior to the sintering process, the preheating process is provided in which at least the vicinity of the sintering-process-start end of the soot preform 4 is preheated in the temperature atmosphere of 800° C. or more and 1300° C. or less for a range of 30 minutes or more and 480 minutes or less. This allows the OH concentration in the vicinity of the sintering-process-start end to be 20 ppm or less, and accordingly, the transmission loss of the optical fiber can be smaller.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

The operations, procedures, steps, stages, or the like of each process performed by a device, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” for convenience in the claims, embodiments, or diagrams, it does not necessarily mean that the process must be performed in this order.

### Explanation of References

1: sintering furnace; 2: main heater; 3: furnace core tube; 4: soot preform (glass preform); 4a: straight body portion; 4b: tapered portion; 4c: central axis; 5: preform-receiving stand; 6: reverse pole; 7: handle portion; 8: heat shield plate; 9: hanging shaft; 10: infrared light measuring apparatus; 11: infrared light radiation mechanism; 12: infrared light reception mechanism; 13: calculation mechanism.

What is claimed is:

1. A manufacturing method of an optical fiber preform, comprising:
depositing SiO₂ fine particles by adhesion onto a starting preform formed of quartz glass to obtain a soot preform, the starting preform including a core having a high refractive index and a cladding having a lower refractive index than the core;
sintering the soot preform to dehydrate and vitrify it sequentially from one end thereof in a dehydration gas atmosphere; and
prior to the sintering, preheating at least a vicinity of a sintering-process-start end of the soot preform.

2. The manufacturing method of an optical fiber preform according to claim 1, wherein
a temperature to perform the preheating is lower than a temperature to perform the sintering.

3. The manufacturing method of an optical fiber preform according to claim 1, wherein
the preheating is performed in a temperature atmosphere of 800° C. or more and 1300° C. or less.

4. The manufacturing method of an optical fiber preform according to claim 1, wherein
the preheating is performed for a range of 30 minutes or more and 480 minutes or less.

5. The manufacturing method of an optical fiber preform according to claim 1, wherein
in the preheating, the soot preform is preheated in an atmosphere that includes at least one or more of N₂, O₂, Ar, He, and Cl₂ gases.

6. The manufacturing method of an optical fiber preform according to claim 1, wherein
the soot preform is rotated at 3 rpm or less in the preheating and/or the sintering.

7. The manufacturing method of an optical fiber preform according to claim 1, wherein
a handle made from quartz glass is attached to both ends of the starting preform formed of the quartz glass, and
in the preheating, an end surface of the handle and/or a side surface of the handle exposed to an outside of the soot preform on a side of the sintering-process-start end is/are installed in a sintering furnace so as to be exposed to radiant heat from a heater for sintering, and radiation from the heater is propagated, as an infrared radiation, through the handle and the starting preform to heat the soot preform from inside.

8. An optical fiber preform formed of quartz glass and including a core having a high refractive index and a cladding having a lower refractive index than the core, wherein
an average of OH concentrations in a radial direction of the optical fiber preform is 25 ppm or less throughout a section of 90% or more in a longitudinal direction.

9. The optical fiber preform according to claim 8, wherein
the average of the OH concentrations in the radial direction is 25 ppm or less throughout an entire section in the longitudinal direction.

10. The optical fiber preform according to claim 8, wherein
a maximum value of the OH concentrations in the radial direction is 30 ppm or less.

11. An optical fiber obtained from the optical fiber preform according to claim 8 and having a transmission loss of 0.29 dB/km or less at a wavelength of 1383 nm.
